(19) United States
(12) Patent Application Publication
(10) Pub. No.: US 2008/0201671 A1
(43) Pub. Date: Aug. 21, 2008

(54) METHOD FOR GENERATING TIMING EXCEPTIONS

(75) Inventors: Housseine Rejouan, Fremont, CA (US); Solaiman Rahim, San Diego, CA (US); Mohammad H. Movahed-Ezazi, Saratoga, CA (US)

Correspondence Address: SUGHRUE MION, PLLC, 2100 Pennsylvania Avenue, N.W., Washington, DC, 20037, US

(73) Assignee: ATRENTA, INC., San Jose, CA (US)

(21) Appl. No.: 11/676,232

(22) Filed: Feb. 16, 2007

(51) Int. Cl. G06F 17/50

(52) U.S. Cl. 716/6

(57) ABSTRACT

A method for generating timing exceptions for integrated circuit (IC) designs is disclosed. The method includes synthesizing an input RTL description into a gate-level netlist mapped to a technology library; detecting timing critical paths in the netlist; and determining for each detected timing critical path whether it induces timing exceptions. The timing exceptions generated by the disclosed method include, but are not limited to, multi-cycle paths, clock domain crossing false paths, asynchronous false paths, functional false paths, combinational false paths, sequential false paths, timing false paths, and the like.

### TECHNICAL FIELD

The present invention relates generally to logic synthesis and timing analysis of integrated circuit (IC) design, and more particularly to a technology for generation of timing exceptions.

### BACKGROUND OF THE INVENTION

In recent years, the size of integrated circuits (ICs) has dramatically increased in both size and number of gates, requiring designers to spend time and effort to meet timing closure for the IC design. Moreover, complexity, speed and deep-submicron effects make timing closure of IC designs a more critical task. In order to enable a designer to achieve accurate timing closure, static timing analyzers and other timing optimization tools are utilized.

In IC design, every path, that originates from either an input port or a register clock pin, must be properly constrained to obtain correct implementation of the register transfer level (RTL hereafter) description. Typically, timing constraints are applied mainly to achieve the following: 1) describing the different attributes of clock signals, such as clock frequency, duty cycle, clock skew, and clock latency; 2) specifying input and output delay requirements of ports relative to a clock transition; and, 3) setting up timing exceptions. Different types of timing exceptions are possible. Some examples of timing exceptions include: set minimum delay, set maximum delay, set disable arc, set false path, set multi-cycle path, and so on.

False paths and multi-cycle paths are timing exceptions which, if not specified, or if not handled correctly, certainly result in not achieving timing closure. False paths are logic paths which cannot be sensitized (1) because they are functionally blocked, or (2) because of delays in reconvergent logic, or (3) because of disabled arcs. As an example, FIG. 1 shows a logic circuit 100 that includes a false path 110 that results from reconvergent logic. That is, in order to allow a signal to propagate on path 110, an input 130 should have the value ‘1’ and ‘0’ at the same time. This can be achieved only if correctly synchronizing the delays of input 130. A static timing analyzer should allow manual specification of false paths and consider them to be unconstrained. In addition, the timing analyzer should be able to automatically determine whether paths are able to be sensitized due to static or dynamic behavior.

Multi-cycle paths are paths which intentionally require more than one clock cycle to propagate data. Since this information cannot possibly be inferred by a timing analyzer, multi-cycles paths need to be specified by the designer. FIG. 2 shows a circuit 200 that includes flip-flops 210-1 through 210-4, two multiplexers (MUX) 220-1 and 220-2, and a combinational logic 230. An input 250 and an output 255 are the primary input and the primary output, respectively. Flip-flops 210-3 and 210-4 constitute a four cycle gray code counter. The state transitions of the gray-code counter are determined by the following sequence:
(0, 0)->(0, 1)->(1, 1)->(1, 0)->(0, 0), . . .

MUX 220-1 selects input 250 when the transition of the gray-code counter is (0, 0), i.e., (FF 210-3, FF 210-4)=(0, 0). Then, flip-flop 210-1 is set to the value at input 250 when (FF 210-3, FF 210-4)=(0, 1). On the other hand, MUX 220-2 selects the output of combinational logic 230 when (FF 210-3, FF 210-4)=(1, 0). Flip-flop 210-2 is then set to the input's value when (FF 210-3, FF 210-4)=(0, 0). Three clocks are required to go from state (0, 1) to state (0, 0). Thus, the path from flip-flop 210-1 to flip-flop 210-2 is a multi-cycle path that uses three clocks cycle to propagate signals. Consequently, the timing constraint of these paths can be relaxed from a single clock cycle to three clock cycles.

In the related art, several techniques are disclosed to perform timing analysis of time exceptions. Examples for such techniques can be found, e.g., in U.S. Pat. Nos. 6,327,692, 6,438,731, 6,532,577, and 6,845,494 and in U.S. application Ser. Nos. 10/166,944, 11/006,349 and 11/063,773 incorporated herein by reference for their useful understanding of the background of the invention, and in particular with respect to the sections of those documents relating to timing analysis of time exceptions. The drawback of these techniques is that timing exceptions (i.e., false and multi-cycle paths) must be manually defined by the designer. As the complexity of digital circuits continues to increase, this approach of having the designer manually define timing exceptions is seen as too time consuming and error-prone. Furthermore, these above-identified prior techniques cannot automatically generate timing exceptions from an RTL description and, thus, such exceptions cannot be verified as early in the design cycle as would be preferred.

It is therefore one object of the invention, among others that will become apparent to the reader, to provide a solution for automatically generating timing exceptions from a RTL level description of an IC design.

### BRIEF DESCRIPTION OF THE DRAWINGS

FIG. 1 is a schematic diagram of a logic circuit that includes a false path (prior art).

FIG. 2 is a schematic diagram of a logic circuit that includes a multi-cycle path (prior art).

FIG. 3 is a flowchart describing the method for generating timing exception in accordance with an embodiment of the present invention.

FIG. 4 is a flowchart describing the process for performing timing optimization.

FIG. 5 is a schematic diagram of a logic circuit for exemplifying the operation of the present invention.

FIG. 6 is a block diagram of a system for generating timing exception in accordance with an embodiment of the present invention.

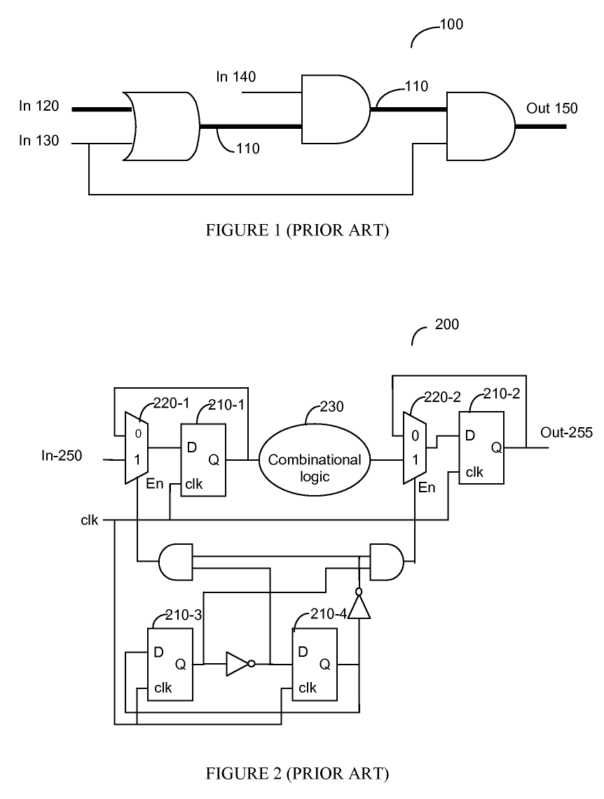

### DETAILED DESCRIPTION OF THE INVENTION

Now disclosed, by of a detailed description of some representative simplified examples, is an automated method for generating timing exceptions for integrated circuit (IC) designs. The method includes synthesizing an input register transfer level (RTL) description into a gate-level netlist mapped to a technology library; detection of timing critical paths in the netlist; and determining for each detected timing critical path whether it induces timing exceptions. The timing exceptions generated by the disclosed method include, but are not limited to, multi-cycle paths, clock domain crossing false paths, asynchronous false paths, functional false paths, combinational false paths, sequential false paths, timing false paths, and the like.

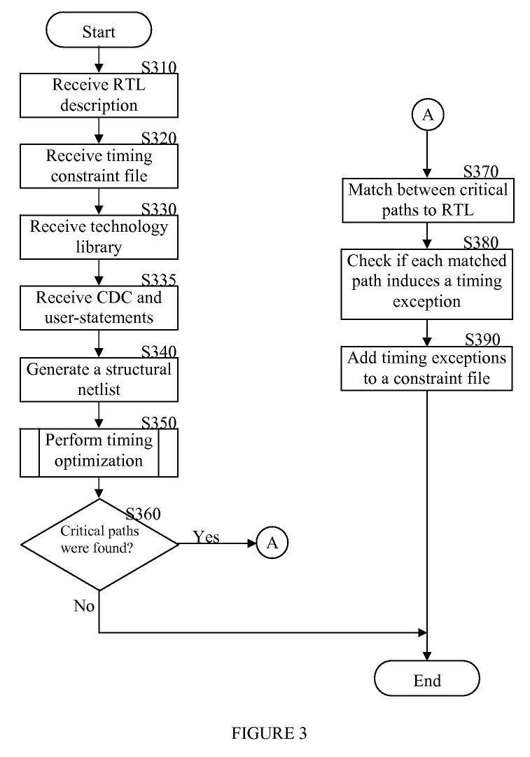

FIG. 3 shows a non-limiting and exemplary flowchart 300 describing a method for generating timing exceptions in accordance with one embodiment of the present invention. At S310, a code representing a RTL description of an IC design is received. The code may be in any hardware description language (HDL) including, but not limited to, Verilog, VHDL and the like. At S320, a timing constraint file, including at least clock definitions as well as input and output delays, is received. The constraint file may be, for example, in a Synopsys design constraints (SDC) format and may be used to constrain the design for a logic synthesis tool. At S330, a technology library, e.g., in a liberty library format “LIB”, including specific information regarding cells of a selected process technology, is received. Optionally, at S335, a file that includes a list of clock domain crossing definitions and a list of user-defined statements are received. The user-defined statements allow for the acceleration of the timing exceptions generation. As an example, these statements may define a specific area of the design for which to generate the exceptions. The user may designate, for example, timing critical starting points, endpoints, through points, and a list of timing critical paths. The user may also define the type or types of exceptions to generate, i.e., false paths, multi-cycle paths, functional false paths, asynchronous false paths, sequential false paths, combinational false paths, and so on.

At S340, a synthesized netlist is produced by an IC synthesis tool (this may also be referred to as generating a structural netlist). Synthesis tools produce a gate level netlist based on a RTL representation (i.e., the RTL description received in step S310), a timing constraint file (from S320), and a technology library (from S330). A netlist generally includes logic gates such as AND, NAND, NOR, OR, XOR, NXOR, NOT, IC blocks, multipliers, adders, memories, and so on. In addition a netlist includes the interconnection between the logical gates and different blocks. One such synthesis tool is disclosed in a U.S. Pat. No. 6,993,733 entitled “Apparatus and Method for Handling of Multi-Level Circuit Design Data”, assigned to the common assignee and hereby incorporated by reference for all that it contains, and in particular the section dealing with generating a structural netlist. At S350, a process for performing timing optimization is executed.

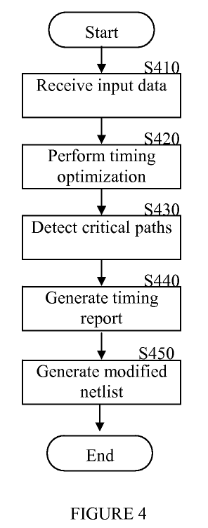

Referring to FIG. 4, the execution of S350 is shown in detail. At S410, the process receives input data. In this example, the input data includes the structural netlist produced at step S340, the technology library, and the timing constraints file. At S420, an attempt is made to optimize the timing of paths in the input netlist. For example, to optimize the fanout of a gate, the fanout is divided into critical and non-critical parts and a buffer tree is inserted to drive the timing critical fanouts. As another example, a gate may be replaced with another gate in its logic class in the library to achieve better timing, this process is called resizing.

At S430, a static timing analyzer is executed so timing critical paths in the design are detected. The timing critical paths are paths with negative slack. Slack measures how closely a timing constraint is satisfied. Positive slack indicates that a constraint is satisfied with a safety margin equal to the slack value. Circuits with positive slack are usually considered to be over-designed, since the slack indicates that the circuit could either be operated at a higher speed or redesigned to operate at the same speed using less area and/or power. Negative slack indicates that a constraint is unsatisfied and cannot be satisfied unless delays in the circuit are modified by the amount of the slack. At S440, a timing report that includes all timing critical paths detected in the netlist is output. At S450, a file that includes all modifications made in the netlist during timing optimization is generated (i.e., a final mapped netlist).

Referring back to FIG. 3, at S360 a check is made to determine if timing critical paths are found in the final netlist. If such paths were identified, execution continues with S370; otherwise, execution terminates. At S370, a process is executed to match the timing critical paths, in the final mapped netlist, to the RTL netlist. All the matched paths are candidates for timing exceptions. That is, each such path may be a false path or a multi-cycle path. At S380, for each of the critical paths, a Boolean satisfiability solver is used to determine whether the path satisfies a false path condition, a multi-cycle condition, or none of them. The Boolean satisfiability solver may include, but is not limited to, SAT, ATPG, BDD, and the like. Various types of false paths can be detected including, but not limited to, clock domain crossing (CDC) false paths, asynchronous false paths (set, reset, scan input, and scan output), functional false paths, combinational false paths, sequential false paths, and timing false paths. At S390, all paths that were verified as false or multi-cycle paths are output as a file or, preferably, added to the timing constraint file provided at S320. In accordance with one embodiment all paths added to the constraint file may be compacted to generate a readable constraint file.

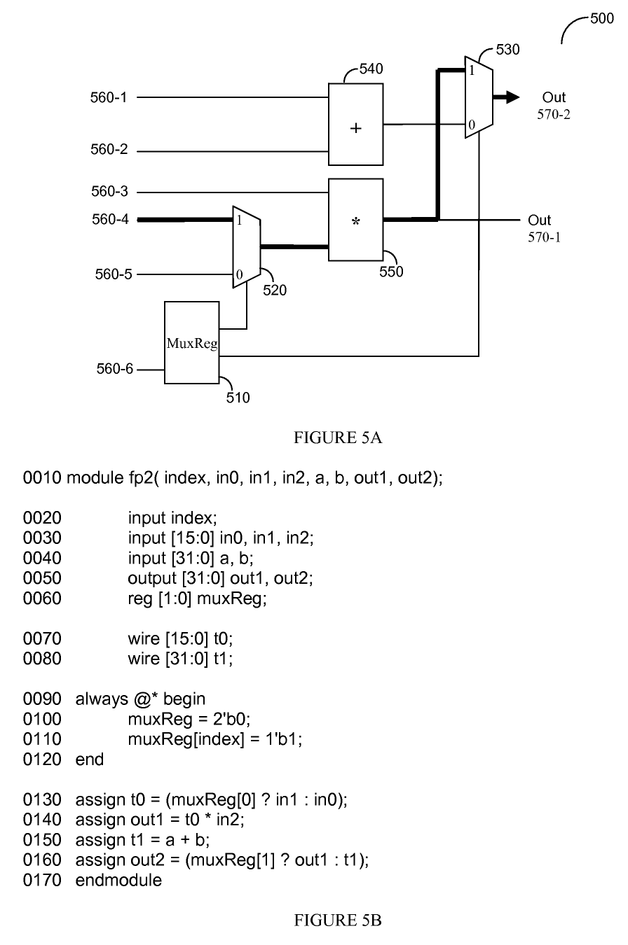

What now follows is a non-limiting example for the operation of the method for generating timing exceptions. FIG. 5A shows a schematic diagram of a logic circuit 500 that includes a register 510, multiplexers (MUX) 520 and 530, an adder 540, and a multiplier 550. The circuit 500 further includes six inputs 560-1 through 560-6 and two outputs 570-1 and 570-2. The RTL code representing circuit 500 is shown in FIG. 5B. From all possible paths in circuit 500 two are considered as critical paths P1 and P2:
P1=from In_560-4 through MUX 520 through multiplier 550 to Out_570-1
P2=from In_560-4 through MUX 520 through multiplier 550 through MUX530 to Out 570-2

The solver simulates conditions to determine if a signal can be propagated on P1 and P2. That is, if for a set of input values the values at outputs are changed. It can be noticed that path P1 is active if the input ‘1’ of MUX 520-1 is selected. On the other hand, to propagate a signal on P2, the inputs ‘1’ of both MUXes 520 and 530 must be selected. As defined in the RTL code provided in FIG. 5B (lines 0090-0120), register 510 is a “hot-one” register, i.e., a register that outputs exclusive values, and therefore the inputs ‘1’ of both MUXes 520 and 530 cannot be selected as simultaneously. Thus, P2 is a false path.

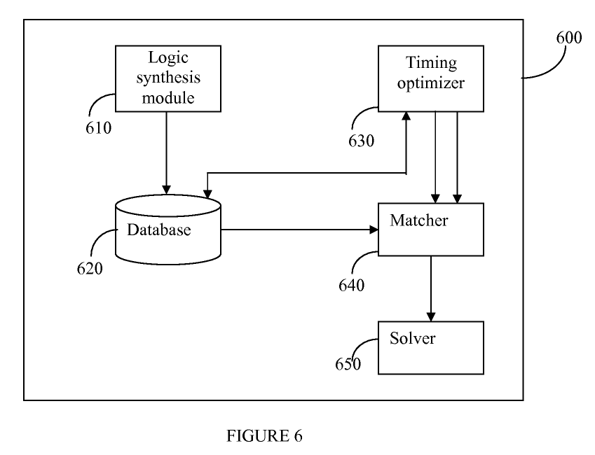

FIG. 6 shows a non-limiting block diagram of a system 600 used for generating timing exceptions in accordance with one embodiment of the present invention. System 600 includes a logic synthesis module 610, a database 620, a timing optimizer 630, a matcher 640, and a solver 650. Logic synthesis module 610 receives a RTL description, a timing constraint file, and a technology library; this module generates a netlist mapped to the technology library. The netlist is saved in database 620. Timing optimizer 630 performs timing optimizations on the generated netlist and detects timing critical-paths as already discussed in detail above. Timing optimizer 630 outputs modifications made to the netlist, which are also written to database 620, and a list of critical paths. Matcher 640 makes a comparison between the detected timing critical paths and the updated netlist in database 620 to determine if the paths are found in the netlist. Each path that is found also in the netlist is transferred to solver 650 that verifies if the path induces a timing exception, i.e., whether it is a false path or multi-cycle path. The solver may be any type of satisfiability solver, such as SAT, ATPG, BDD, and the like. Paths that were verified as timing exceptions, by the solver 650, are saved in timing constraint file.

Many variations to the above-identified embodiments are possible without departing from the scope and spirit of the invention. Possible variations have been presented throughout the foregoing discussion. Combinations and subcombinations of the various embodiments described above will occur to those familiar with this field, without departing from the scope and spirit of the invention.

There is claimed:

1. A method for generating timing exceptions for an integrated circuit (IC) design, the method comprising:
receiving a register transfer level (RTL) description of the IC design;
synthesizing the RTL description to a gate-level netlist;
detecting timing critical paths in the netlist; and
determining, for each detected timing critical path, whether it induces timing exceptions.

2. The method of claim 1, further comprising determining whether the timing critical paths are found in the netlist.

3. The method of claim 1, further comprising generating a file that includes the timing exceptions.

4. The method of claim 2, wherein the timing exceptions include at least one of: false paths, multi-cycle paths.

5. The method of claim 4, wherein the false paths include at least one of: clock domain crossing false paths, asynchronous false paths, functional false paths, combinational false paths, sequential false paths, timing false paths.

6. The method of claim 1, wherein the RTL description is in the form of any hardware description language (HDL).

7. The method of claim 1, wherein receiving the RTL description further comprising receiving: a technology library, a timing constraint file.

8. The method of claim 7, wherein the generated netlist is mapped to the technology library.

9. The method of claim 1, wherein the timing critical paths are paths with a negative slack.

10. The method of claim 9, wherein detecting the timing critical paths further comprises: performing timing optimizations.

11. The method of claim 4, wherein determining whether the timing critical path is a false path comprises determining whether a false path condition is satisfied.

12. The method of claim 11, wherein the false path condition indicates whether the timing critical path is functionally blocked or reconvergent logic.

13. The method of claim 11, wherein determining whether the false path condition is satisfied is performed using a satisfiability solver.

14. The method of claim 4, wherein determining whether the timing critical path is a multi-cycle path comprises determining whether a multi-cycle path condition is satisfied.

15. The method of claim 14, wherein the multi-cycle path condition indicates whether the timing critical path requires more than one clock cycle to propagate data.

16. The method of claim 15, wherein determining whether the false path condition is satisfied is performed using a satisfiability solver.

17. The method of claim 1, implemented in one of a computer aided design (CAD) system and a CAD program.

18. A computer program product for enabling a computer system to perform operations for an integrated circuit (IC) design method, intended for generating timing exceptions for the IC design, the computer program product having computer instructions on a computer readable medium, the operations comprising:
receiving a register transfer level (RTL) description of the IC design;
synthesizing the RTL description to a gate-level netlist;
detecting timing critical paths in the netlist; and
determining for each detected timing critical path whether it induces timing exceptions.

19. The computer program product of claim 18, further comprising determining whether detected timing critical paths includes in the netlist.

20. The computer program product of claim 18, further comprising generating a file that includes the timing exceptions.

21. The computer program product of claim 20, wherein the timing exceptions include at least one of: false paths, multi-cycle paths.

22. The computer program product of claim 20, wherein the false paths include at least one of: clock domain crossing false paths, asynchronous false paths, functional false paths, combinational false paths, sequential false paths, timing false paths.

23. The computer program product of claim 18, wherein the RTL description is in the form of any hardware description language (HDL).

24. The computer program product of claim 18, wherein receiving the RTL description further comprising receiving a technology library, a timing constraint file.

25. The computer program product of claim 24, wherein the generated netlist is mapped to the technology library.

26. The computer program product of claim 18, wherein the timing critical paths are paths with a negative slack.

27. The computer program product of claim 25, wherein detecting the timing critical paths further comprises performing timing optimizations.

28. The computer program product of claim 20, wherein determining whether the critical path is a false path comprises determining whether a false path condition is satisfied.

29. The computer program product of claim 27, wherein the false path condition indicates whether the critical path is functionally blocked or reconvergent logic.

30. The computer program product of claim 27, wherein determining whether the false path condition is satisfied is performed using a satisfiability solver.

31. The computer program product of claim 20, wherein determining whether the timing critical path is a multi-cycle path comprises determining whether a multi-cycle path condition is satisfied.

32. The computer program product of claim 30, wherein the multi-cycle path condition indicates whether the critical path requires more than one clock cycle to propagate data.

33. The computer program product of claim 30, wherein determining whether the false path condition is satisfied is performed using a satisfiability solver.

34. The computer program product of claim 18, implemented in one of a computer aided design (CAD) system and a CAD program.

35. A system for generating timing exceptions for an integrated circuit (IC) design, comprising:
a logic synthesis module for generating a gate-level netlist from register transfer level (RTL) description of the IC design;
a database for maintaining the generated netlist;
a timing optimizer for detecting timing critical paths in the netlist; and
a satisfiability solver for determining for each detected timing critical path whether it induces timing exceptions.

36. The system of claim 35, further comprises a matcher for determining whether timing critical paths are found in the netlist.

37. The system of claim 36, wherein the timing exceptions include at least one of: false paths, multi-cycle paths.

38. The system of claim 37, wherein the false paths include at least one of: clock domain crossing false paths, asynchronous false paths, functional false paths, combinational false paths, sequential false paths, timing false paths.

39. The system of claim 35, wherein the RTL description is in the form of any hardware description language (HDL).

40. The system of claim 35, wherein the generated netlist is mapped to an input technology library.

42. The system of claim 35, wherein the timing critical paths are paths with a negative slack.

43. The system of claim 42, wherein timing optimizer is further being capable of performing timing optimizations using an input timing constraint file.

44. The system of claim 37, wherein the satisfiability solver determines whether the timing critical path is a false path by determining whether a false path condition is satisfied.

45. The system of claim 44, wherein the false path condition indicates whether the critical path is functionally blocked or reconvergent logic.

46. The system of claim 35, wherein the satisfiability solver is at least one of a SAT, a ATPG, a BDD.

47. The system of claim 37, wherein the satisfiability solver determines whether the critical path is a multi-cycle path by determining whether a multi-cycle path condition is satisfied.

48. The system of claim 47, wherein the multi-cycle path condition indicates whether the critical path requires more than one clock cycle to propagate data.
